(19) United States
(12) Patent Application Publication
(10) Pub. No.: US 2007/0239355 A1
(43) Pub. Date: Oct. 11, 2007

(54) Method and apparatus for preventing separation of accompanying persons

(75) Inventors: Ji Heon Oh, Yongin-si (KR); Hyun Su Hong, Seongnam-si (KR); Kyong Ha Park, Suwon-si (KR); Jong Sun Pyo, Suwon-si (KR); Jae Myeon Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/705,801

(22) Filed: Feb. 13, 2007

(30) Foreign Application Priority Data
Apr. 7, 2006 (KR) 2006-0032095

(51) Int. Cl. G01C 21/00

(52) U.S. Cl. 701/211; 701/209; 701/213

(57) ABSTRACT

Disclosed herein are a method and apparatus for preventing separation of accompanying persons by using a first apparatus and a second apparatus connected through a short-range wireless communication network. The method includes: calculating self-locations of the first and second apparatuses; exchanging the self-locations with each other; calculating a distance between the first and second apparatuses using the self-locations; outputting, if the distance between the first and second apparatuses exceeds a pre-set distance, an alarm for warning a separation state and designating current locations of the first and second apparatuses as absolute locations; detecting self-travel routes from the absolute locations of the first and second apparatuses; exchanging the detected self-travel routes with each other; and displaying the travel routes of counterparts.

### PRIORITY

This application claims priority under 35 U.S.C. § 119 from Korean Patent Application No. 2006-0032095, which was filed in the Korean Intellectual Property Office on Apr. 7, 2006, the contents of which are incorporated herein by reference.

### BACKGROUND OF THE INVENTION

1. Field of the Invention

The present invention generally relates to a method and apparatus for preventing separation of accompanying persons, and more particularly, to a method and apparatus for preventing separation of accompanying persons by using a first apparatus and a second apparatus connected through a short-range wireless communication network.

2. Description of the Related Art

In a modern society, people often journey as a family unit to rural areas or visit places crowded with people such as a resort, park and department store during weekends, holidays and vacations. In such crowded places, children often become separated from their caregivers due to a lack of attention by the caregiver or because the children are attracted to something.

To prevent a child from becoming separated, a conventional apparatus for preventing a missing child is used in which wireless communication (for example, Bluetooth, RFID or RF transmission/reception) is executed and information such as an alarm or vibration is generated when the caregiver and child are separated from each other by a predetermined distance or when communication between them is interrupted. The caregiver and child each have an element of the apparatus, and thereby separation between the child and care giver may be prevented.

FIG. 1 shows a schematic configuration of a conventional apparatus for preventing a missing child. Referring to FIG. 1, the conventional apparatus for preventing a missing child comprises a transmission module 10 for transmitting radio waves at a predetermined time interval and a reception module 20 for receiving the radio waves from the transmission module 10. The transmission module 10 preferably is a mobile communication terminal having a mobile communication function.

In such a conventional apparatus for preventing a missing child, radio waves having short wavelengths (for example below 1 meter) are transmitted by the transmission module 10 at a predetermined time interval, and received by the reception module 20. If the reception module 20 cannot receive the radio waves, the reception module 20 generates an alarm (for example, a beep sound or voice guide message) to warn that a caregiver and child are separated from each other beyond the distance that the radio waves can reach. That is, the conventional apparatus for preventing a missing child only gives a warning in a beep sound or by voice to inform a caregiver or child that they are separated from each other beyond a predetermined distance.

Accordingly, when a caregiver and child are separated from each other beyond a distance that radio waves can reach, they cannot identify the other's location using a conventional apparatus. In particular, in a place or time crowded with people, it is difficult to find a person located in a place beyond a certain distance using only a warning sound. That is, a conventional apparatus for preventing a missing child cannot identify a location of an accompanying person (for example, a caregiver or child) and thereby has a difficulty in finding the accompanying person.

### SUMMARY OF THE INVENTION

The present invention has been made in view of the above problems, and an object of the present invention is to provide a method and apparatus for preventing separation of accompanying persons by sharing information on relative locations of the accompanying persons using mobile communication terminals.

Another object of the present invention is to provide a method and apparatus for easily finding a counterpart when separation of accompanying persons occurs.

Another object of the present invention is to provide a method and apparatus for checking the safety of a counterpart by identifying whether a danger factor exists in a region in which a counterpart is located using local geographical information.

To achieve the above objects, a method for preventing separation of accompanying persons using a first apparatus and a second apparatus connected through a short-range wireless communication network includes calculating, by the first and second apparatuses, self-locations of the first and second apparatuses; exchanging, by the first and second apparatuses, the self-locations with each other; calculating a distance between the first and second apparatuses using the self-locations of the first and second apparatuses; outputting, if the distance between the first and second apparatuses exceeds a pre-set distance, an alarm for warning a separation state and designating current locations of the first and second apparatuses as absolute locations; detecting, by the first and second apparatuses, self-travel routes from the absolute locations of the first and second apparatuses; exchanging, by the first and second apparatuses, the detected self-travel routes with each other; and displaying, by the first and second apparatuses, travel routes of counterparts.

Preferably, the method for preventing separation further includes identifying whether a danger factor exists near the travel routes of the first and second apparatuses according to stored local geographical information and outputting an alarm if a danger factor exists near the travel routes of the first and second apparatuses.

Preferably, the step of identifying whether a danger factor exists further includes identifying whether the distance between the first and second apparatuses exceeds a pre-set distance.

Preferably, the output alarm is provided as an audible alarm sound.

It is also preferable, at the step of outputting an alarm, to display a danger guide message window. The counterpart's travel routes are also preferably displayed in a text form.

Further, at the step of displaying travel routes of counterparts, an electronic map corresponding to a region including the travel routes of the first and second apparatuses is detected from an electronic map stored in advance and the travel routes of the counterparts are displayed on the detected electronic map.

The step of exchanging the self-locations is further preferably repeated at a pre-set time interval.

Preferably, the step of calculating self-locations further includes receiving GPS data from GPS satellites; sensing travel directions and travel speeds of the first and second apparatuses; and calculating the self-locations of the first and second apparatuses using the GPS data, sensed travel direction and sensed travel speed.

The pre-set distance is preferably below 2 meters.

To achieve the above objects, an apparatus for preventing separation of accompanying persons includes a first apparatus and a second apparatus connected through a short-range wireless communication network, wherein the first and second apparatus each comprises: a short-range communication network interface for transmitting/receiving data through the short-range wireless communication network; a location data input unit for inputting location data of the first and second apparatuses; a self-location calculator for calculating self-locations of the first and second apparatuses using the location data; a travel route detector for detecting travel routes of the first and second apparatuses using the location data; a distance calculator for calculating the distance from a counterpart using a location of the counterpart transmitted through the short-range communication network interface and the calculated self-location; a controller for, if the distance calculated by the distance calculator exceeds a pre-set distance, controlling the travel route detector to detect a self-travel route of the apparatus by designating a current location of the apparatus as an absolute location and controlling the short-range communication network interface to exchange the detected self-travel route with the counterpart; and a display unit for displaying a travel route of the counterpart transmitted through the short-range communication network interface.

The display unit will preferably display the travel route of the counterpart in a text form.

It is also preferable for the apparatus to further include a map storage unit for storing an electronic map, wherein the display unit displays the travel route of the counterpart on a detected electronic map after detecting from the map storage unit an electronic map corresponding to a region including the travel route of the counterpart.

The apparatus also preferably includes a geographical information storage unit for storing local geographical information and an alarm output unit for outputting an alarm, wherein the controller searches the geographical information according to the travel routes of the first and second apparatuses, identifies whether a danger factor exists near to the travel routes of the first and second apparatuses, and controls, if a danger factor exists, the alarm output unit to output an alarm.

Preferably, the controller determines whether a danger factor exists when the distance from the counterpart exceeds the pre-set distance.

Preferably, the alarm output unit outputs an audible alarm sound.

It is also preferable for the alarm output unit to display a danger guide message window on the display unit.

The controller will preferably controls the short-range communication network interface to transmit the self-location to the counterpart at a pre-set time interval.

The location data input unit will preferably include comprises a GPS receiver for receiving GPS data to calculate the absolute locations of the first and second apparatuses; and a sensing unit for receiving sensing data to calculate displacements of the first and second apparatuses.

Further, the sensing unit will preferably include an acceleration sensor for detecting a travel speed of a corresponding apparatus; a geomagnetic sensor for detecting a travel direction of the corresponding apparatus; and an altitude sensor for detecting an altitude of the corresponding apparatus.

In addition, it is preferable for the self-location calculator to calculate the self-location of the apparatus using the GPS data and sensing data.

### BRIEF DESCRIPTION OF THE DRAWINGS

The above and other objects, features and advantages of the present invention will be more apparent from the following detailed description in conjunction with the accompanying drawings, in which:

FIG. 1 shows a schematic configuration of a conventional apparatus for preventing a missing child;

FIG. 2 shows a schematic configuration of an apparatus for preventing separation of accompanying persons according to a first embodiment of the present invention;

FIG. 3 is a block diagram illustrating an apparatus for preventing separation of accompanying persons according to a second embodiment of the present invention; and

FIG. 4 is a flowchart illustrating a method for preventing separation of accompanying persons according to a third embodiment of the present invention.

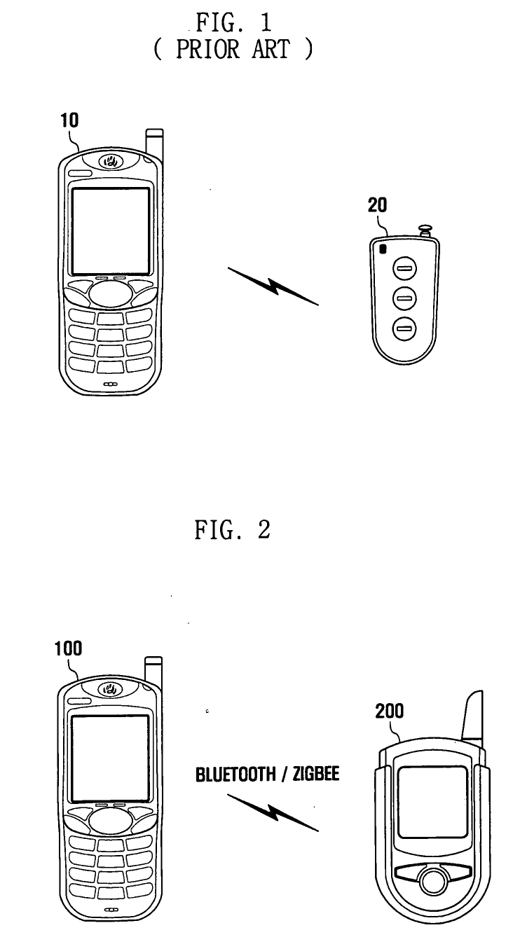

### DESCRIPTION OF THE PREFERRED EMBODIMENTS

Hereinafter, preferred embodiments of the present invention are described in detail with reference to the accompanying drawings. The same reference numbers are used to identify the same or corresponding elements in the drawings. Some constructions or processes known in the art are not described to avoid obscuring the invention in unnecessary detail.

FIG. 2 shows a schematic configuration of an apparatus for preventing separation of accompanying persons according to an embodiment of the present invention.

Referring to FIG. 2, the apparatus for preventing separation of accompanying persons includes a first apparatus 100 and a second apparatus 200 each having a display unit and user interface. The first and second apparatuses 100 and 200 are connected to each other by a short-range wireless communication network. The short-range wireless communication network preferably uses a communication specification (for example, Bluetooth® or ZigBee®) that can maintain communication connection at a distance above 100 meters for the first and second apparatuses 100 and 200 to exchange location information when they are located in a distance above 100 meters. Additionally, the first and second apparatuses 100 and 200 automatically calculate relative locations (for example, a direction, distance and altitude) of the apparatuses of accompanying persons (for example, of a parent and child) using sensors such as an acceleration sensor, geomagnetic sensor and altitude sensor.

When accompanying persons (for example, a parent and child) respectively having the first and second apparatuses 100 and 200 are separated from each other beyond a predetermined distance (for example, 2 meters), the first and second apparatuses 100 and 200 display relative locations (for example, a distance, direction and altitude, such as a story in a building) of the counterpart apparatus and outputs an alarm, and thereby the locations of the separated counterparts (for example, a parent and child) may be identified. That is, the present invention enables separated counterparts to be easily found using the displayed location information. In particular, a location of a counterpart, regardless of the age of the counterpart, may be easily identified using location information and the counterpart may be found without any effort.

The first and second apparatuses 100 and 200 preferably are mobile communication terminals.

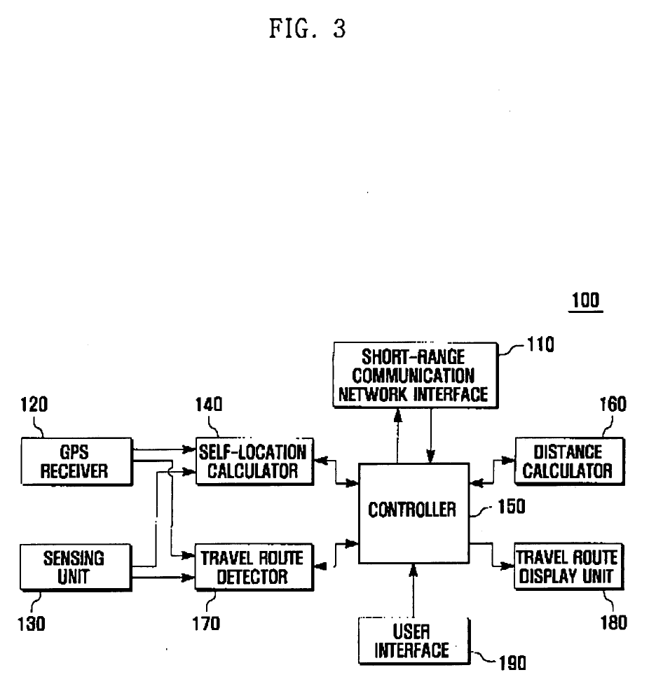

FIG. 3 is a block diagram illustrating an apparatus for preventing separation of accompanying persons according to another embodiment of the present invention. In particular, FIG. 3 shows an example of the configuration of the first apparatus 100 shown in FIG. 2.

Referring to FIG. 3, the first apparatus 100 includes a short-range communication network interface 110, a Global Positioning System (GPS) receiver 120, a sensing unit 130, a self-location calculator 140, a controller 150, a distance calculator 160, a travel route detector 170, a travel route display unit 180 and a user interface 190.

The short-range communication network interface 110 transmits/receives data through a short-range wireless communication network (for example, Bluetooth® or ZigBee®). In particular, the short-range communication network interface 110 transmits a self-location calculated in the self-location calculator 140 to a counterpart, and receives the calculated result of a location of the counterpart. For example, the short-range communication network interface 110 transmits the calculated result of a location of the first apparatus 100 to the second apparatus 200 shown in FIG. 2, and receives the calculated result of a location of the second apparatus 200 to identify whether the first apparatus 100 is separated from the second apparatus 200.

Additionally, the short-range communication network interface 110 transmits a travel route detected by the travel route detector 170 to a counterpart, and receives a travel route of the counterpart. For example, the short-range communication network interface 110 transmits the detected result of a travel route of the first apparatus 100 to the second apparatus 200 shown in FIG. 2, and receives the detected result of a travel route of the second apparatus 200 to be informed of a location of a counterpart.

The GPS receiver 120 and sensing unit 130 receive location data of the first apparatus 100. In particular, the GPS receiver 120 receives GPS data from GPS satellites to calculate an absolute location of the first apparatus 100, and the sensing unit 130 receives sensing data to calculate displacement of the first apparatus 100, namely, relative location information (for example, travel direction, travel speed and altitude). For this, the sensing unit 130 preferably includes an acceleration sensor for detecting a travel speed of the first apparatus 100; a geomagnetic sensor for detecting a travel direction of the first apparatus 100; and an altitude sensor for detecting an altitude of the first apparatus 100.

As described above, the first apparatus 100 preferably includes the GPS receiver 120 and sensing unit 130 to calculate a self-location. However, external modules may be used as the GPS receiver 120 and sensing unit 130. For example, when the first apparatus 100 is a portable phone, the GPS receiver 120 and sensing unit 130 are manufactured as a module interfaceable in a standard 24 pin form or wirelessly, and when the first apparatus 100 is a Personal Digital Assistant (PDA), the GPS receiver 120 and sensing unit 130 are manufactured in an SDIO (Secure Digital Input/Output) or CF (Compact Flash) type or in a wirelessly interfaceable module.

The self-location calculator 140 calculates a self-location of the first apparatus 100 using location data input through the GPS receiver 120 and sensing unit 130. That is, the self-location calculator 140 calculates a self-location of the first apparatus 100 using GPS data received from the GPS receiver 120 and sensing data input through the sensing unit 130. Various methods for calculating a self-location by the self-location calculator 140 using the GPS data and sensing data are already known in the art and are preferably used herein.

A method for calculating a self-location of the first apparatus 100 by the self-location calculator 140 depends on whether the first apparatus 100 is located inside or outside a room. The difference is caused by whether GPS data is receivable. That is, when the first apparatus 100 is located outside a room where GPS data is receivable, the self-location calculator 140 accurately calculates in real time an absolute location, travel direction, altitude and travel speed of the first apparatus 100 using GPS data received through the GPS receiver 120 and sensing data input through the sensing unit 130, whereas when the first apparatus 100 is located in a room in which GPS data is not receivable, the self-location calculator 140 calculates a self-location of the first apparatus 100 using only sensing data input through the sensing unit 130.

When only sensing data is used as described above, the self-location calculator 140 should determine an absolute location that will be a base point between the first apparatus 100 and a counterpart. Accordingly, when the first apparatus 100, located in a room, is separated from a counterpart, the self-location calculator 140 determines a specific location (for example, the location immediately prior to separation) designated by the controller 150 as an absolute location. If the first apparatus 100 is separated from the counterpart by a predetermined distance, the location that the first apparatus 100 has relatively moved from the absolute location is calculated using information on a travel direction, travel speed, distance, and altitude change in a building from the absolute location.

The controller 150 controls the operation of components included in the first apparatus 100 by a pre-set control algorithm or a user selection information input through the user interface 190. That is, the controller 150 controls the operation of the short-range communication network interface 110, self-location calculator 140, distance calculator 160, travel route detector 170 and travel route display unit 180.

In particular, the controller 150 controls the short-range communication network interface 110 to exchange the calculated result of self-locations of the first and second apparatuses 100 and 200 with a counterpart (namely, the second apparatus 200), and controls the distance calculator 160 to calculate the distance between the first apparatus 100 and second apparatus 200. After the distance calculator 160 calculates the distance, the controller 150 determines whether the distance exceeds a pre-set distance (for example, within 2 meters, preferably within 1 meter), and outputs, if the distance between the first apparatus 100 and second apparatus 200 exceeds the pre-set distance, an alarm for informing of a separation state.

In addition, the controller 150 controls the travel route detector 170 to detect a travel route of the first apparatus 100 by designating a current location of the first apparatus 100 as an absolute location, and controls the short-range communication network interface 110 to transmit the detected travel route to the counterpart. In this case, the travel route preferably includes a distance, direction and altitude from an absolute location (namely, a current location of the first apparatus 100).

In addition, the controller 150 preferably controls the short-range communication network interface 110 to transmit the self-location of the first apparatus 100 to the counterpart at a pre-set time interval.

The distance calculator 160 calculates the distance between the first and second apparatuses 100 and 200 using a location of the second apparatus 200 transmitted through the short-range communication network interface 110 and a calculated self-location of the first apparatus 100. The distance calculator 160 preferably calculates the distance by using absolute locations of the first and second apparatuses 100 and 200. However, when the first apparatus 100 is located in a room, GPS data may not be received and the absolute location may not be calculated. In this case, preferably, the distance calculator 160 designates a pre-set location as an absolute location and calculates the distance between the first and second apparatuses 100 and 200 by calculating travel distances of the first and second apparatuses 100 and 200 from the absolute location.

The travel route detector 170 detects a travel route of the first apparatus 100 by using location data received from the GPS receiver 120 and sensing unit 130. For this end, the travel route detector 170 is preferably operated by the control of the controller 150. The method for detecting a travel route by the travel route detector 170 is known to those of skill in the art. For example, preferably, the travel route detector 170 determines an absolute location as a base point between itself and a counterpart, and detects a travel route based on the absolute location. When the first apparatus 100 is located outside a room, the travel route detector 170 calculates an absolute location, direction, altitude, and travel speed that the first apparatus 100 moved from the base point by using GPS data received through the GPS receiver 120 and sensing data input through the sensing unit 130, and detects a travel route of the first apparatus 100 by using the above information. When the first apparatus 100 is located inside a room, because the travel route detector 170 typically cannot receive GPS data from the GPS receiver 120, preferably, the travel route detector 170 detects information on the number of a user's steps, travel distance, travel speed, travel direction and a story change in a building using only sensing data input from the sensing unit 130; calculates a location of the first apparatus 100 relatively moved from the base point; and detects the travel route of the first apparatus 100 using the calculated result.

The location immediately prior to separation is preferably designated as an absolute location when the first apparatus 100 is separated from the second apparatus 200 by a predetermined distance.

The travel route display unit 180 displays a travel route of the second apparatus 200 transmitted through the short-range communication network interface 110 under the control of the controller 150. The travel route display unit 180 preferably displays the travel route of the second apparatus 200 in text form.

When the first apparatus 100 stores an electronic map, for example, if the first apparatus 100 further includes a map storage unit (not shown) storing an electronic map, preferably, the travel route display unit 180 detects an electronic map corresponding to a region including the travel route of the second apparatus 200 from the map storage unit and displays a travel route of the second apparatus 200 on the detected electronic map.

When the first apparatus 100 further includes a geographical information storage unit (not shown) storing local geographical information or receives local geographical information, the controller 150 searches the geographical information according to the travel routes of the first and second apparatuses 100 and 200, and determines whether a danger factor exists near the travel routes of the first and second apparatuses 100 and 200. The controller 150 preferably determines whether a danger factor exists near the second apparatus 200 when a distance between the first and second apparatuses 100 and 200 exceeds a pre-set distance.

If a danger factor exists, the controller 150 preferably controls output of an alarm. For this, the first apparatus 100 further preferably includes an alarm output unit (not shown) to output the alarm.

At this time, preferably, the controller 150 controls an alarm output unit to output an alarm sound or to display a danger guide message window on the travel route display unit 180.

FIG. 3 shows a configuration of the first apparatus 100 in the apparatus shown in FIG. 2 for preventing separation of accompanying persons. The second apparatus 200 shown in FIG. 2 has a configuration similar to the first apparatus 100 described above. That is, the first apparatus 100 and second apparatus 200 should have components shown in FIG. 3 in common to exchange location information. Therefore, a detailed description for a configuration of the second apparatus 200 shown in FIG. 2 is omitted.

Preferably, the first and second apparatuses 100 and 200 include communication modules (not shown) known in the art to provide a mobile communication service.

When a caregiver and child have the first and second apparatuses 100 and 200, respectively, for preventing separation of accompanying persons according to the present invention, a network is formed between the apparatuses. For example, the first and second apparatuses 100 and 200 are connected by a communication network such as Bluetooth® or ZigBee®, and bi-directional communication between the apparatuses is possible. In addition, the apparatuses have sensors (for example, a geomagnetic sensor, acceleration sensor and altitude sensor) to detect their relative location information and thereby can calculate location information of each apparatus.

Accordingly, the apparatus for preventing separation of accompanying persons according to an embodiment of the present invention calculates location information of a caregiver and child by using specific locations (for example, current location of a corresponding apparatus, a previous location or a common location designated in advance) as absolute locations using the above characteristics when the caregiver and child are separated further than a predetermined distance, exchanges the calculated result and displays the result on the counterpart's display unit. For example, an apparatus of a parent displays location information of a child (for example, a distance from the parent, direction and story in a building), and an apparatus of the child displays location information of the parent (for example, a distance from the child, direction and story in a building). The apparatus of the child preferably displays location information in a form easily understandable by children.

Accordingly, the present invention has an advantage that separation of accompanying persons may be prevented by identifying location information of each other.

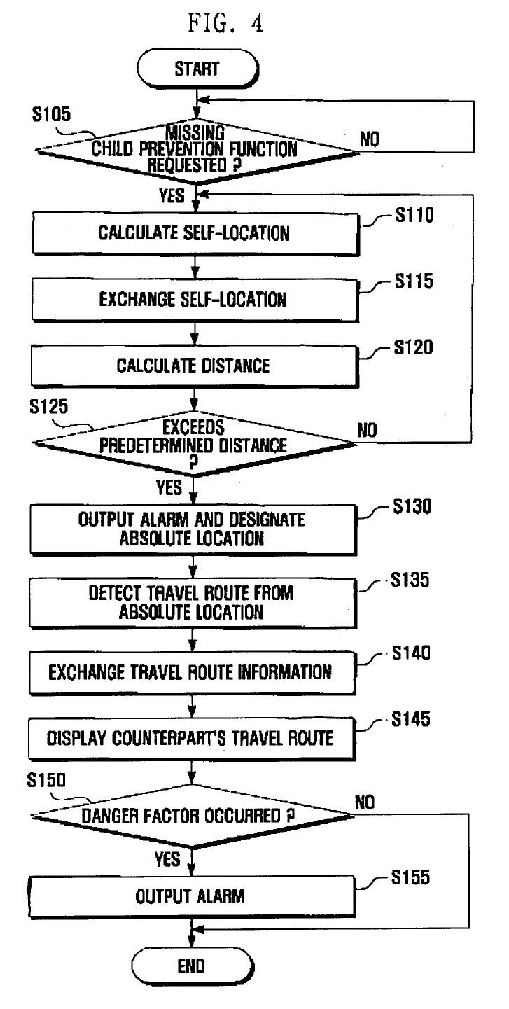

FIG. 4 is a flow chart illustrating a method for preventing separation of accompanying persons according to another embodiment of the present invention.

FIG. 4 shows a method for preventing separation of accompanying persons using the first apparatus 100 and the second apparatus 200 connected through a short-range wireless communication network. A processing procedure in the first apparatus 100 is described in FIG. 4, with reference to FIG. 3.

If a function of preventing a missing child is set and execution of the function is requested in the first apparatus 100 in step S105, the controller 150 controls the self-location calculator 140 to calculate a self-location of the first apparatus 100 in step S110. To this end, preferably, the self-location calculator 140 receives GPS data from the GPS receiver 120, receives from the sensing unit 130 sensing data (namely, information on travel direction and speed) of the first apparatus 100 and calculates a location of the first apparatus 100 using the GPS data and sensing data. Preferably, various technologies known in the art related to GPS systems are used to calculate a location using the GPS data and sensing data.

The first apparatus 100 exchanges its calculated self-location information with the second apparatus 200 shown in FIG. 2 in step S115. Preferably, the short-range communication network interface 110 transmits the calculated value of a location of the first apparatus 100, and receives the calculated value of a location of the second apparatus 200, using a communication network such as Bluetooth® or ZigBee®.

The above step S115 is preferably repeated at a predetermined time interval.

The controller 150 of the first apparatus 100 that has received a self-location of the second apparatus 200 in the above step S115 calculates the distance between the first and second apparatuses 100 and 200 using self-locations of the first and second apparatuses 100 and 200 in step S120. Preferably, various technologies known in the art related to GPS system application are used to calculate the distance.

The controller 150 identifies whether the calculated distance exceeds a pre-set distance (for example, within 2 meters, preferably 1 meter) in step S125. If the calculated distance exceeds the pre-set distance, the controller 150 outputs an alarm warning of a separation state, and designates an absolute location as a base for detecting a travel route of the first apparatus 100 in step S130. The absolute location preferably is any one selected from the group consisting of a current location of the first apparatus 100, a previous location and a pre-set specific location.

The controller 150 detects a travel route of the first apparatus 100 from the absolute location in step S135. The controller 150 exchanges the detected travel route of the first apparatus 100 with that of the second apparatus 200 in step S140. Preferably, the short-range communication network interface 110 transmits the detected value of a travel route of the first apparatus 100, and receives the detected value of a travel route of the second apparatus 200, using a communication network such as Bluetooth® or ZigBee®.

The controller 150 of the first apparatus 100, having received the detected value of the travel route of the second apparatus 200, displays the travel route of the second apparatus 200 on the travel route display unit 180 in step S145. The travel route is preferably displayed in a text form or on an electronic map. When the travel route is displayed on an electronic map, the controller 150 preferably stores an electronic map in advance, detects from the electronic map storage an electronic map corresponding to a region including the travel route of the first and second apparatuses 100 and 200, and displays a travel route of the second apparatus 200 on the detected electronic map.

The travel route preferably includes a distance, direction and story in a building from an absolute location.

The first apparatus 100 displaying a travel route of the second apparatus 200 will preferably store local geographical information or receive local geographical information through a communication network. The first apparatus 100 identifies in step S150 whether a danger factor exists near travel routes of the first and second apparatuses 100 and 200 using the geographical information, and outputs an alarm if a danger factor exists in step S155.

Whether a danger factor exists is preferably determined when the distance between the first and second apparatuses 100 and 200 exceeds a pre-set distance.

Preferably, an alarm is output as an alarm sound, or a danger guide message window is displayed on the travel route display unit 180.

As apparent from the above description, the present invention has the effects that separation of accompanying persons may be prevented by sharing relative location information with accompanying persons and, if separation occurs, a counterpart may easily be found. In addition, the present invention has an advantage that safety of a counterpart may be identified by identifying whether a danger factor exists in a region at which the counterpart is located by using local geographical information. In particular, a child may identify a location of a caregiver by provision of visual information to the child.

While this invention has been particularly shown and described with reference to preferred embodiments thereof, the present invention is not limited to the above embodiments and it will be understood by those skilled in the art that various substitutions, modifications and changes may be made herein without departing from the spirit and scope of the invention as defined by the appended claims.

What is claimed is:

1. A method for preventing separation of accompanying persons using a first apparatus and a second apparatus connected through a short-range wireless communication network, comprising the steps of:
calculating, by the first and second apparatuses, self-locations of the first and second apparatuses;
exchanging, by the first and second apparatuses, the self-locations with each other;
calculating a distance between the first and second apparatuses using the self-locations;
outputting, if the distance between the first and second apparatuses exceeds a pre-set distance, an alarm warning of separation state and designating current locations of the first and second apparatuses as absolute locations;
detecting travel routes from the absolute locations of the first and second apparatuses;
exchanging the detected travel routes; and
displaying, by the first and second apparatuses, travel routes of counterparts.

2. The method for preventing separation of accompanying persons of claim 1, wherein the travel route includes a distance, direction and altitude from the absolute location.

3. The method for preventing separation of accompanying persons of claim 1, further including:
identifying whether a danger factor near the travel routes according to stored local geographical information; and
outputting an alarm if a danger factor exists is identified.

4. The method for preventing separation of accompanying persons of claim 3, wherein the identification of whether a danger factor exists includes identifying whether the distance between the first and second apparatuses exceeds a pre-set distance.

5. The method for preventing separation of accompanying persons of claim 3, wherein the output alarm is an alarm sound.

6. The method for preventing separation of accompanying persons of claim 3, wherein a danger guide message window is displayed when the alarm is output.

7. The method for preventing separation of accompanying persons of claim 1, wherein the counterpart's travel routes are displayed in text form.

8. The method for preventing separation of accompanying persons of claim 1, wherein the display of travel routes of counterparts includes display of an electronic map corresponding to a region including the travel routes of the first and second apparatuses detected from an electronic map stored in advance and the travel routes of the counterparts are displayed on the detected electronic map.

9. The method for preventing separation of accompanying persons of claim 1, wherein the exchange of self-locations is repeated at a pre-set time interval.

10. The method for preventing separation of accompanying persons of claim 1, wherein calculating self-locations includes:
receiving GPS data from GPS satellites;
sensing travel directions and travel speeds of the first and second apparatuses; and
calculating the self-locations of the first and second apparatuses using the GPS data, sensed travel direction and sensed travel speed.

11. The method for preventing separation of accompanying persons of claim 4, wherein the pre-set distance is below 2 meters.

12. An apparatus for preventing separation of accompanying persons comprising a first apparatus and a second apparatus connected through a short-range wireless communication network,
wherein the first and second apparatus each comprise:
a short-range communication network interface for transmitting/receiving data through the short-range wireless communication network;
a location data input unit for inputting location data;
a self-location calculator for calculating self-locations using the location data;
a travel route detector for detecting travel routes of the first and second apparatuses using the location data;
a distance calculator for calculating distance from a counterpart using a location of the counterpart first or second apparatus transmitted through the short-range communication network interface and the calculated self-location;
a controller for, if the distance calculated by the distance calculator exceeds a pre-set distance, controlling the travel route detector to detect a travel route of the apparatus by designating a current location of the apparatus as an absolute location and controlling the short-range communication network interface to exchange the detected travel route with the counterpart; and
a display unit for displaying a travel route of the counterpart transmitted through the short-range communication network interface.

13. The apparatus for preventing separation of accompanying persons of claim 12, wherein the travel route includes a distance, direction and altitude from the absolute location.

14. The apparatus for preventing separation of accompanying persons of claim 12, wherein the display unit displays the travel route of the counterpart in text form.

15. The apparatus for preventing separation of accompanying persons of claim 12 further comprising a map storage unit for storing an electronic map, wherein the display unit displays the travel route of the counterpart on a detected electronic map after detecting from the map storage unit an electronic map corresponding to a region including the travel route of the counterpart.

16. The apparatus for preventing separation of accompanying persons of claim 12 further comprising:
a geographical information storage unit for storing local geographical information; and
an alarm output unit for outputting an alarm,
wherein the controller searches the geographical information according to the travel routes of the first and second apparatuses, identifies whether a danger factor exists near the travel routes of the first and second apparatuses, and controls, if a danger factor exists, the alarm output unit outputs an alarm.

17. The apparatus for preventing separation of accompanying persons of claim 16, wherein the controller determines whether a danger factor exists when the distance from the counterpart exceeds the pre-set distance.

18. The apparatus for preventing separation of accompanying persons of claim 16, wherein the alarm output unit outputs an alarm sound.

19. The apparatus for preventing separation of accompanying persons of claim 16, wherein the alarm output unit displays a danger guide message window on the display unit.

20. The apparatus for preventing separation of accompanying persons of claim 12, wherein the controller controls the short-range communication network interface to transmit the self-location to the counterpart at a pre-set time interval.

21. The apparatus for preventing separation of accompanying persons of claim 12, wherein the location data input unit comprises:
a GPS receiver for receiving GPS data to calculate the absolute locations of the first and second apparatuses; and
a sensing unit for receiving sensing data to calculate displacements of the first and second apparatuses.

22. The apparatus for preventing separation of accompanying persons of claim 21, wherein the sensing unit includes:
an acceleration sensor for detecting a travel speed of a corresponding apparatus;
a geomagnetic sensor for detecting a travel direction of the corresponding apparatus; and
an altitude sensor for detecting an altitude of the corresponding apparatus.

23. The apparatus for preventing separation of accompanying persons of claim 21, wherein the self-location calculator calculates the self-location of the apparatus using the GPS data and sensing data.

24. The apparatus for preventing separation of accompanying persons of claim 12, wherein the pre-set distance is below 2 meters.

25. The apparatus for preventing separation of accompanying persons of claim 12, wherein the first and second apparatuses are mobile communication terminals.
